(19) United States
(12) Patent Application Publication
(10) Pub. No.: US 2022/0101238 A1
(43) Pub. Date: Mar. 31, 2022

(54) Computer implemented method of capturing and processing data from user activities in business processes and a computer program to implement this method

(71) Applicant: XPLUS SPOLKA AKCYJNA, Warsaw (PL)

(72) Inventors: Tomasz Drobiazg, Warsaw (PL); Artur Zyzak, Warsaw (PL); Piotr Lukow vel Broniszewski, Bedzin (PL); Pawel Chmielewski, Lublin (PL)

(73) Assignee: XPLUS SPOLKA AKCYJNA, Warsaw (PL)

(21) Appl. No.: 17/035,766

(22) Filed: Sep. 29, 2020

(30) Foreign Application Priority Data
Sep. 28, 2020 (CN) PL435477

(51) Int. Cl. G06Q 10/06; G06F 16/901; G06F 16/9035

(52) U.S. Cl. CPC G06Q 10/06398; G06Q 10/0633; G06F 16/9035; G06F 16/9024; G06Q 10/06395

(57) ABSTRACT

A computer implemented method of capturing and processing data from user activities in business processes, involving the saving of output data on the individual operations of users (actions) downloaded from the ERP system as JSON files which are combined in aggregated events reflecting the undertakings of a user (activities). Activities constituting series of clicks within the same working template of the application are subsequently grouped into graphs, which are assigned subsequent numbers and unique pairs of edges, upon which graphs comprising identical edges are grouped into archetypes. The invention also relates to a computer program containing instructions which, when the program is executed by a computer, cause the computer to carry out above mentioned steps.

The object of the invention is a computer-assisted method for capturing and processing data on business processes and a computer program used to implement this method.

A business process is a series of interconnected operations or tasks, which is supposed to lead to the achievement of an expected result or a solution to a problem being faced. From an IT point of view, a business process is in turn a set of undertakings converting an input into an output. Organised business processes used in companies allow the unification and standardisation of sequences of operations in order to achieve a specific goal important for an organisation. The 5-degree process maturity model CMMI is frequently used to determine the level of advancement of processes in a company. The first level includes companies which do not use any processes at all, and the highest one includes organisations systemically utilising process management, i.e. in a methodical manner utilising management structures, resources, knowledge and principles for making decisions and supporting the business objectives of processes.

The implementation of the process model in companies is almost entirely conditioned by the activation of proper software supporting process handling. Proper modeling of the course of processes, the possibility of their monitoring and tracing proper indicators (KPI) in terms of improvement and optimisation, constitute a critical aspect translating into the ability to achieve a business success. Currently, automation of the identification and monitoring of users in a system executing implemented processes is becoming more common, and tools for the aggregation and exploration of data are being developed.

Computer programs assist in not just imposing, but also identifying actual business processes occurring in a given organisation. During such identification of business processes, information is acquired about the indicators and steps of processes, which should: describe the operations of specified processes, define those who execute the respective operations, define selected factors for entering individual operations, determine proper products of distinguished operations, indicate the receivers of these products, define the standardised time of execution of the distinguished operations and determine the category and number of defined processes and operations, present the relationships occurring between processes and operations (process maps). For example, the PCF model (Process Classification Framework), known in Poland as the APQC model, is very helpful when identifying and constructing a map of processes.

Modern integrated ERP and CRM systems supporting the management of a company (including Microsoft Dynamics 365) are designed according to the process control model, which assumes that each employee in a team executes the same steps as part of identical stages for each interaction with the client (defined as the receiver of the effect of the process), collecting and saving data during this process. Business processes enable everyone to operate according to the rules of Best Practices, even when performing undertakings which are rare or unconventional. Subsequent process steps are often combined in the form of a workflow, whose progress can be traced on an interface.

Each system of the ERP and CRM class provides the ability to implement business processes in a configured standard. However, most mature organisations expand their processes, adjusting them to the specifics of the performed operations. Therefore, the automation of downloading process data directly from an interface during work seems to be the most reliable method for building process models for a specific company. This is because it very often turns out that employees of organisations do not operate in ERP or CRM-type systems according to established processes. At the same time, the administrators of systems face major difficulties when determining the actual operations of users. This happens for several reasons, including due to the high degree of complication of corporate class systems, as well as the excessive complexity of the very processes executed in these systems, or processes with insufficient planning in terms of the efficiency of their execution, or insufficient training of employees executing work in these systems.

On the market, there are existing “Process Mining”-type systems utilising algorithms making up sequences of undertakings from files logging the executions of a task in processes (the so-called log files), or straight from the database of the system. These solutions utilise two sources of information to generate a map of processes performed in systems by users, namely system logs and tables of databases with information on the executed objects. However, they do not reflect the actual operations of users, but a linear record of the executions of individual business objects in a process implemented in the ERP system. Known systems do not answer questions related to the actual work of a user, their navigation through the interface of the application, the more or less efficient browsing of information, or the sequence of executing individual actions which cannot be defined entirely as business objects. This is mainly caused by limitations of ERP-type specialised systems, since if such a system were to collect all data on the operations of users, it would very soon collapse under the enormous amount of data which it would have to store. This is why in system logs we will only find information on the chronology of executions of individual events and objects in processes.

Therefore, a technical problem which requires resolving involves the development of a new method for acquiring a limited amount of data on business processes, which would however faithfully reflect the actual operations of users. The object of the solution according to the invention is a computer implemented method of capturing data relating to all undertakings of a user, followed by their processing by “folding” these enormous data streams into actual, real objects, which in a faithful manner reflect the user's operations in an ERP-type system. Therefore, the use of the solution according to the invention does not subject an ERP system to overloads caused by the generation of enormous amounts of data, since it is the computer program implementing the method according to the invention—being an entity independent of the system in which the recording of the users' behaviours takes place—which is responsible for the flow and capturing of data.

The computer implemented method of capturing and processing data from user activities in business processes involves saving output data on the individual operations of users (actions) downloaded from the ERP system as JSON files; subsequently, the JSON files are combined into aggregated events reflecting the undertakings of a user (activities); upon which the activities constituting series of clicks in the same working template of an application are grouped into graphs, which are assigned subsequent numbers and unique pairs of edges, and graphs comprising identical edges are grouped into archetypes.

Preferably, JSONs are labeled with distinguishing flags.

The object of the invention is also a computer program containing instructions which, when the program is executed by a computer, cause the computer to carry out following steps:
a) output data on the individual operations of users (actions) downloaded from the ERP system are saved as JSON files; subsequently,
b) the JSON files are combined into aggregated events reflecting the undertakings of a user (activities); upon which,
c) activities constituting series of clicks in the same working template of the application are grouped into graphs which are assigned subsequent numbers and unique pairs of edges; and subsequently,
d) graphs comprising identical edges are grouped into archetypes.

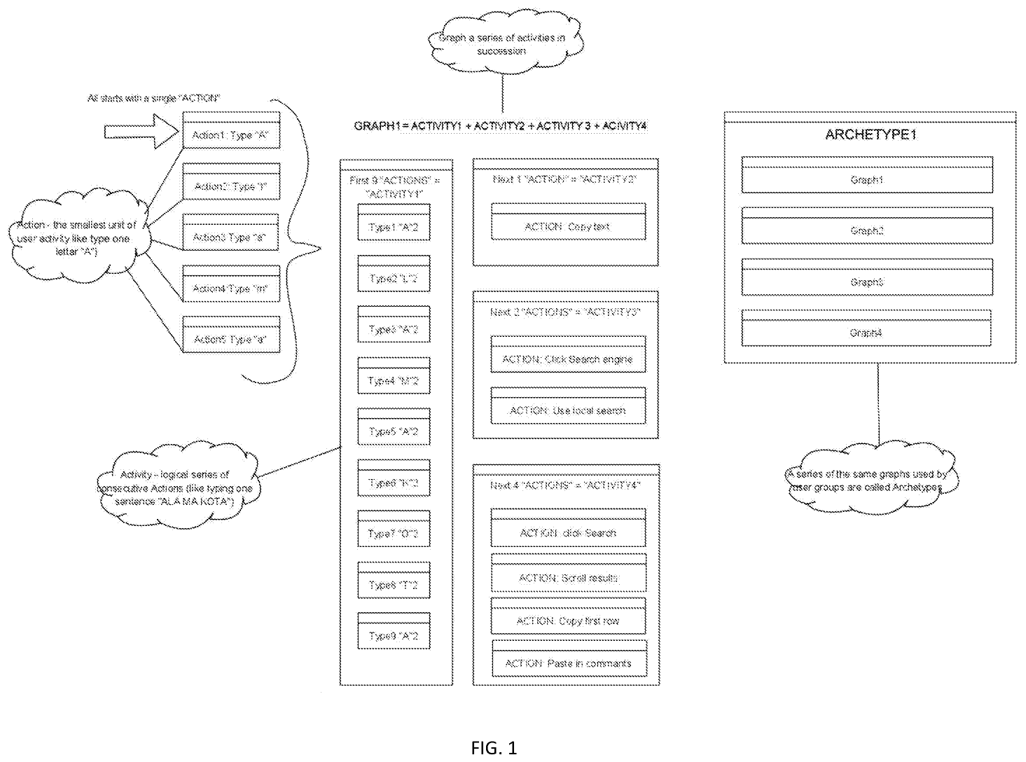

The method according to the invention is presented in a graphical form in FIG. 1. The solutions according to the invention are based on proper generalisation of information. The method is based on monitoring the ERP system and downloading from it input data saved as JSON files. These files store information on the individual operations of users (called actions), e.g. the individual clicks of a mouse, or the typing of a single character from a keyboard. Afterwards, the individual actions are combined into aggregated events (called activities) reflecting the undertakings of a user, e.g. the typing of a text by the user. An activity is a more general term than an action, since it groups individual actions taken by a user; for example, in the sentence “Alice has a cat” each click on the keyboard is an action, but the complete text is an activity. Actions being the consecutive clicks of the same button in an interface of the ERP system are also presented as a single activity. In order to maintain the relations between the original data (JSON files) and the most generalised ones, a flag distinguishing actions from activities is generated at each record in the database. Individual activities are in turn grouped into graphs, which form series of clicks in one and the same working template of the application. Subsequent activities within the same template are assigned the same graph number; therefore, when a user moves to a new template, the algorithm starts a new graph and gives the next number to activities within the current template. Change of the template is detected by comparison to the earlier template present within a single session of the user. Graphs are in turn grouped into archetypes, which constitute identically executed series of clicks with ignored loops. Therefore, archetypes are identical micro-patterns of behaviours, due to which we can distinguish repetitive undertakings. As part of a group defined by a single template and graph, unique pairs of edges are collected, and subsequently, grouping is performed based on templates and graphs, which results in collecting a set of identical edges within each template. This allows observing the repetitive behaviours of users of the studied ERP system.

1. A computer implemented method of capturing and processing data from user activities in business processes comprising steps:
a) output data on the individual operations of users (actions) downloaded from the ERP system are saved as JSON files; subsequently,
b) the JSON files are combined into aggregated events reflecting the undertakings of a user (activities); subsequently,
c) activities constituting series of clicks within the same working template of the application are grouped into graphs which are assigned subsequent numbers and unique pairs of edges; subsequently,
d) graphs comprising identical edges are grouped into archetypes.

2. The method according to claim 1, characterised in that the JSON files are labeled with distinguishing flags.

3. A computer program containing instructions which, when the program is executed by a computer, cause the computer to carry out steps according to claim 1.
